(19) United States
(12) Patent Application Publication
(10) Pub. No.: US 2002/0003885 A1
(43) Pub. Date: Jan. 10, 2002

(54) Enhanced encryption of digital communication system

(75) Inventor: Donald C. Mead, Carlsbad, CA (US)

Correspondence Address: OPPENHEIMER WOLFF & DONNELLY LLP, 840 NEWPORT CENTER DRIVE, SUITE 700, NEWPORT BEACH, CA, 92660, US

(73) Assignee: Digital Cinema Systems Corporation

(21) Appl. No.: 09/733,431

(22) Filed: Dec. 8, 2000

Related U.S. Application Data
(60) Provisional application No. 60/169,711, filed on Dec. 8, 1999.

(51) Int. Cl. H04L 9/28

(52) U.S. Cl. 380/269; 380/43; 380/28

(57) ABSTRACT

This system enhances the security of a digital communication system by adding a new axis of encryption. This is achieved by randomly varying the connection pattern of the interleaver utilized in a Turbo coding system.

### BACKGROUND OF THE INVENTION

1. Field of the Invention

This invention involves an improved security technique for coded, encrypted digital communication.

2. Description of the Related Art

In a conventional digital communication system, the information bits are encrypted with some technique and then some form of Forward Error Correction (FEC) is applied. In the decoder, the order is reversed: the FEC is removed and then decrypted. The security is whatever is contained in the encryption of the information bits.

### SUMMARY OF THE INVENTION

In 1993, the discovery of Turbo codes permitted transmission approaching the Shannon limits. At least for broadcast applications, Turbo codes are rapidly being implemented. In an example, the encoder for a Turbo code consists of a convolutional encoder, an interleaver, a second encoder, and puncturing electronics.

Normally, the interleaver is fixed. For example, it may be written by columns and read out by rows. In this invention the connection of the interleaver is pseudo random. Consider, as an example that a frame consists of one use of all of the storage elements in the interleaver. By changing the interleaver connection pseudo randomly after some number of frames, the attacker has to not only solve the original encryption problem, but now must also solve the pseudo random interconnection of the interleaver.

### BRIEF DESCRIPTION OF THE DRAWINGS

FIG. 1 shows the block diagram for an example Turbo encoder.

FIG. 2 shows the block diagram for the convolutional decoder.

FIG. 3 shows a schematic of the interleaver.

### DETAILED DESCRIPTION OF THE INVENTION

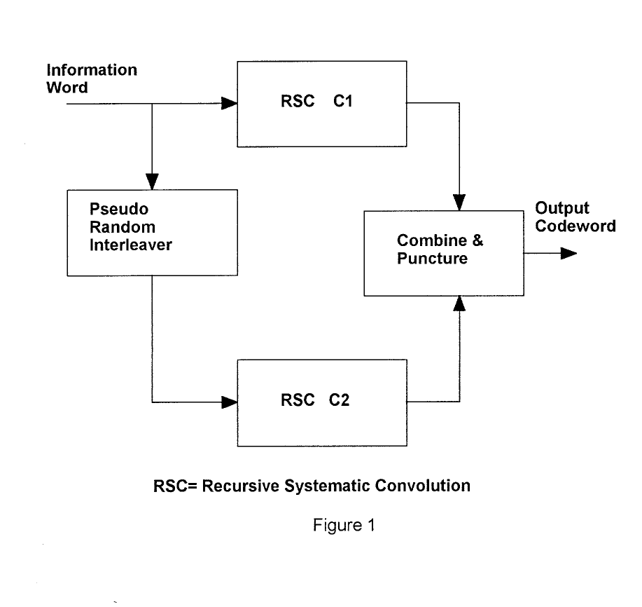

FIG. 1 shows the basic structure of an example Turbo encoder. An information data stream enters the encoder and goes to both the Recursive Systematic Convolution (RSC) coder C1 and the Pseudo Random Interleaver (PRI). As an example, let RSC C1 be ½ rate, so it generates 2 bits for each input bit. When the PRI has been filled, its outputs are coded by RSC C2. Each input bit thus generates 4 output bits. However, since the coders are systematic, the input bit is the same from both coders, one can be discarded. Thus, without puncturing, the natural code rate would be ⅓. However, with puncturing every other code bit can be discarded with the result being a rate ½ code.

The Interleaver can be considered as an array of storage elements. One implementation is as a 1 bit layer Random Access Memory (RAM).

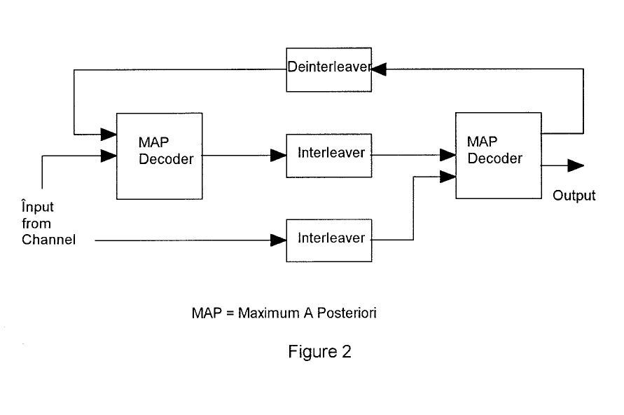

For completeness, a Turbo decoder is shown in FIG. 2. The maximum a posteriori (MAP) decoders correspond to the 2 encoders in the encoder (FIG. 1). The two interleavers are the same as the interleaver in FIG. 1. The Deinterleaver in FIG. 2 is the inverse of the interleaver. It is the feedback represented by the Deinterleaver that provides the power of the Turbo codes to iteratively improve performance.

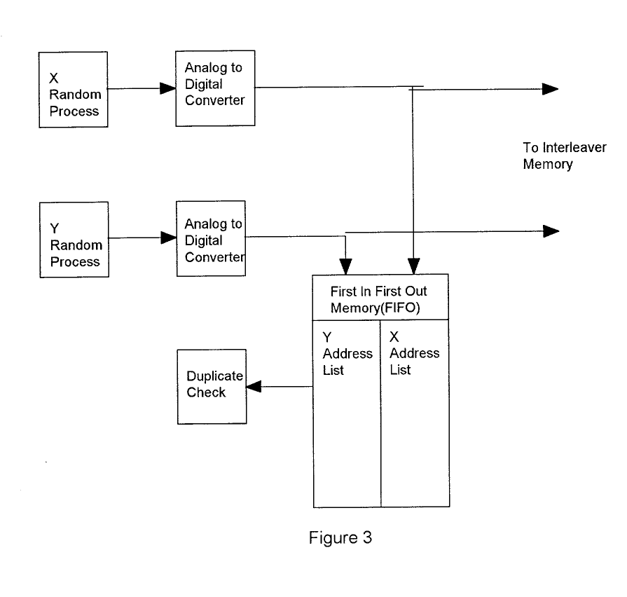

There are a number of ways in which one might pseudo randomly vary the interleaver connection. This means changing the location where each incoming bit is stored in the Interleaver memory. One such technique is shown in FIG. 3. It is assumed that the Interleaver memory is a RAM organized in a rectangular array where each memory cell is selected by an XY address. Referring to FIG. 3, two Random Process generators create independent random values(the noise output of a resistor for example). These values are each converted to digital form by an Analog to Digital (ADC) converter. These digital signals become the address for the Interleaver memory and are stored in the First In First Out memory.

The Checker compares an incoming location with those already stored in the FIFO and selects a new, unused value.

At the beginning of a new cycle(Interleaver connection) the contents of the FIFO are encrypted and broadcast to all of the receivers for that broadcast.

For example, the FIFO contents could be encrypted with DES (AES) and this key could be delivered by a public key cryptography technique.

The essence of this technique is to force an attacker to first solve the random interleaver before an attack can be made on the data encryption.

What is claimed is:

1. A system which works in conjunction with a Turbo coding system to provide enhanced security for a digital communication system.

2. The system of claim 1 where the increased security is obtained by varying the connections of the Interleaver inherent in a Turbo coding system.

3. The system of claim 2 where the connection variation is obtained by changing the addresses of a RAM.

4. The system of claim 2 where each new address is obtained by selecting an X and Y address from a random process.

5. The system of claim 2 where the address sequence for the Interleaver is itself coded and sent to the receivers.

6. A system for securing data transmission comprising:
a data signal generator;
an encoder in communication with said data signal generator, said encoder including an address memory system operative to correlate an address with information added to a data signal by said encoder;
a random address location generator in communication with said address memory system; and,
a decoder in communication with said encoder.

7. A system according to claim 6, wherein said address memory system is an interleaver memory.

8. A system according to claim 7, wherein said address memory system includes a RAM rectangular array configuration defined by an XY address system.

9. A system according to claim 8, wherein said random address location generator includes an X random process generator and a Y random process generator.

10. A system according to claim 6, wherein said system includes a random address memory in communication with said random address location generator operative to store addresses generated by said random address location generator.

11. A system according to claim 10, wherein said random address memory is a first in first out (FIFO) memory.

12. A system according to claim 10, wherein said system includes an encryptor in communication with said random access memory.

13. A method of performing secure data transmission comprising:
generating an electronic data stream;
encoding said electronic data stream;
randomly correlating memory address information with code information added to said data stream during said encoding; and,
decoding said electronic data stream.

14. A method according to claim 13, including storing the correlation of said memory address information in a memory.

15. A method according to claim 14, including encoding said correlation of said memory address information and decoding said correlation when decoding said electronic data stream.

16. A method according to claim 13, wherein said random correlation is performed using an interleaver memory.

17. A method according to claim 16, wherein said random correlation is performed using an interleaver organized in a rectangular array configured with an XY address system.

18. A method according to claim 17, wherein said random correlation is performed by randomly selecting an XY address for used by said interleaver memory.

19. A method according to claim 18, including storing said randomly selected XY addresses in a first in first out (FIFO) memory.

20. A method according to claim 19, including encoding said stored randomly selected XY addresses from said FIFO memory and decoding said addresses when decoding said electronic data stream.
